(19) United States
(12) Patent Application Publication
(10) Pub. No.: US 2010/0265029 A1
(43) Pub. Date: Oct. 21, 2010

(54) WINDING STRUCTURE FOR A TRANSFORMER AND WINDING

(75) Inventors: Blue XIONG, Dong-Guan City, Kuang-Dong Province (CN); Jack ZHOU, Dong-Guan City, Kuang-Dong Province (CN); Jing LIU, Dong-Guan City, Kuang-Dong Province (CN); C.S. KUNG, Taoyuan Hsien (TW)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: Delta Electronics, Inc., Taoyuan Hsien (TW)

(21) Appl. No.: 12/484,731

(22) Filed: Jun. 15, 2009

(30) Foreign Application Priority Data
Apr. 17, 2009 (TW) 098206421

(51) Int. Cl. H01F 27/28

(52) U.S. Cl. 336/232

(57) ABSTRACT

A winding structure adapted for a transformer and a winding are provided. The winding structure comprises a first conductive disk, a second conductive disk, a connecting part, and an insulation disk which is disposed between the first conductive disk and the second conductive disk. The first conductive disk has a first open circular portion and a first connection hole, the second conductive disk has a second open circular portion and a second connection hole and the isolation disk has a third connection hole. The first conductive disk, the second conductive disk and the insulation disk are combined by the connecting part through the first connection hole, the second connection hole and the third connection hole, and the first conductive disk is electrically connected with the second conductive disk therefore.

This application claims priority to Taiwan Patent Application No. 098206421 filed on Apr. 17, 2009, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a winding structure for use in a transformer.

2. Descriptions of the Related Art

Because transformers can transform voltages, change impedances and separate circuits, they are often used in a wide variety of electronic products. Meanwhile, windings are known as essential components for voltage transformation in transformers. Nowadays, a number of structural improvements on transformers have been made depending on various usage demands.

FIG. 1 illustrates a winding structure 1 commonly found in conventional transformers is shown therein. The winding structure 1 is mostly formed integrally and is structurally divided into a first winding disk 11 and a second winding disk 12, each of which has a wiring terminal 13. First, the winding structure 1 is stamped from a conductive material (e.g., copper) and then electroplated to prevent oxidization of the winding disks and to facilitate subsequent tin soldering. Afterwards, the winding structure 1 is attached with an insulation adhesive tape on both the front and the back surfaces thereof, and is then stamped a second time in order for the insulation adhesive tape to be properly shaped to coincide with the winding structure 1. In application, the winding structure 1 that results from the previous steps is folded along a line A-A′ so that the first winding disk 11 and the second winding disk 12 overlap with each other to form a coil-like structure, which is then wound with a certain number of the winding structures 1 to form a complete winding.

However, during the second stamping process, burrs that can pierce through the insulation adhesive tape may be generated along the inner peripheries of the first winding disk 11 and the second winding disk 12, making it possible for the first winding disk 11 and the second winding disk 12 to come in contact with each other and cause short-circuit faults therebetween. Consequently, electrical functionalities originally designed for the structure may fail to be satisfied. Furthermore, during the folding process, a fracture may occur at junctures where the first winding disk 11 and the second winding disk 12 join with each other due to the application of an undue force, causing failure of electrical connection between the first winding disk 11 and the second winding disk 12 and consequently making it impossible for the winding structure 1 to function properly. Moreover, for the folded winding structure 1, the two wiring terminals 13 are directly connected to a printed circuit board (PCB), and in subsequent processes, the PCB of the winding structure 1 must be soldered in a solder pot, in which case the insulation adhesive tape attached on the winding structure 1 tends to fuse by the high temperature and lose its insulation properties.

As described above, defects tend to occur in the manufacturing process of the winding structure of conventional transformers, resulting in short circuits, failure in electrical connections and damage to insulation parts. Accordingly, an urgent need remains in the art to provide a winding structure with an improved structure that can eliminate defects, avoid occurrence of short circuits, and maintain electrical connection and insulation effectiveness.

### SUMMARY OF THE INVENTION

To solve the aforesaid problems, an objective of the present invention is to provide a winding structure for use in a transformer, which facilitates the production of the winding as a whole and features desirable stability after being manufactured. Accordingly, the problems of short circuits, failure in electrical connection between winding disks and damage to insulation parts are avoided.

To this end the present invention provides a winding structure for use in a transformer, which comprises a first conductive disk, a second conductive disk, an insulation disk and a connecting part. The first conductive disk has a first open circular portion and a first connection hole. The second conductive disk has a second open circular portion and a second connection hole. The insulation disk, which has a third connection hole, is disposed between the first conductive disk and the second conductive disk and configured to insulate part of the electrical connection between the first open circular portion and the second open circular portion. The connecting part is configured to combine the first conductive disk, the second conductive disk and the insulation disk through the first connection hole, the second connection hole and the third connection hole, and enables the electrical connection between the first conductive disk and the second conductive disk.

As described above, the main components of the winding structure of the present invention are formed separately and then combined together by means of the connecting part. As a result, the conductive components and the insulation components may be stamped separately, thereby preventing the generation of burrs and fractures at the junctures during the stamping process as in the prior art. Furthermore, as compared to the prior art in which an insulation adhesive tape is attached on the winding disks, the insulation disk of the present invention may be made of a material that can endure a high temperature, thereby providing more flexibility in use. Therefore, the problems confronted by the prior art are eliminated in the winding structure of the present invention.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a top view of a winding structure of the prior art;

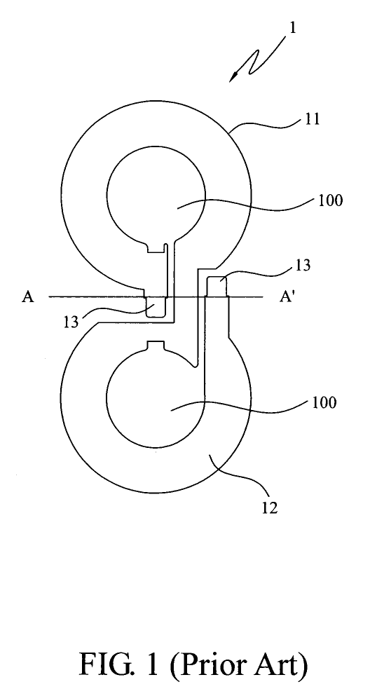

FIG. 2 is a top view of a first conductive disk of the present invention;

FIG. 3 is a top view of a second conductive disk of the present invention;

FIG. 4 is a top view of an insulation disk of the present invention;

FIG. 5 is a schematic assembled view of a winding structure of the present invention;

FIG. 6A is a schematic exploded view of a secondary winding that employs the winding structure of the present invention; and

FIG. 6B is a schematic assembled view of a secondary winding that employs the winding structure of the present invention.

### DESCRIPTION OF THE PREFERRED EMBODIMENT

In the following description, a winding structure of the present invention will be explained with reference to embodiments thereof. However, it shall be appreciated that these embodiments are not intended to limit the present invention to any specific environment, applications or particular implementations described in these embodiments. Therefore, description of these embodiments is only for purpose of illustration rather than to limit the present invention.

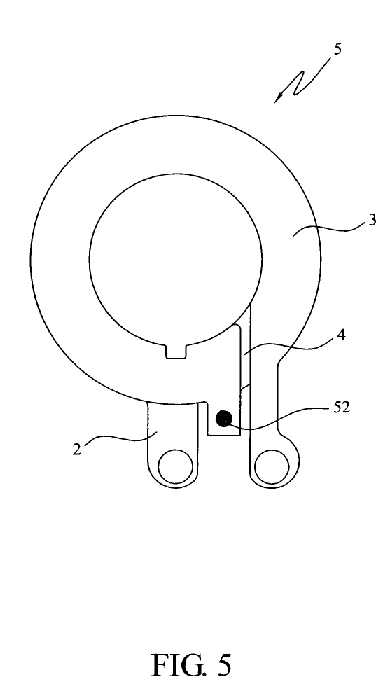

As shown in FIG. 5, an embodiment of the present invention is a winding structure 5, which comprises a first conductive disk 2, a second conductive disk 3, an insulation disk 4 and a connecting part 52.

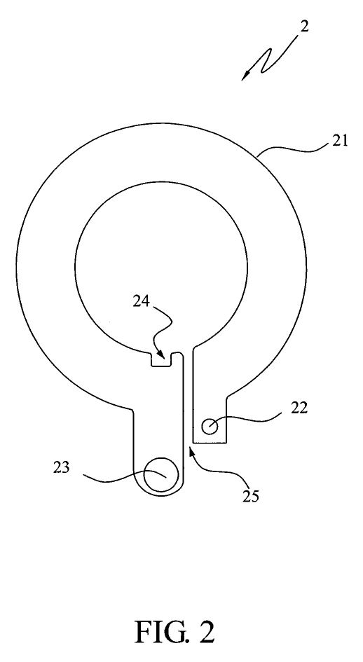

The first conductive disk 2 is substantially of a circular shape having a first open circular portion 21, a first connection hole 22, a first wiring terminal 23 and a notch 24. The first open circular portion 21 is formed with a first opening 25, a schematic view of which is shown in FIG. 2. In other words, the first opening 25 results in the first open circular portion 21 with two separated ends. The first connection hole 22 is formed at one end for connection and fixing purposes, and the first wiring terminal 23 is disposed extending from the other end to connect the power supply terminals. The notch 24 is formed at a circular inner periphery of the first conductive disk 2, and will be described later in terms of its functionality. In this embodiment, the first conductive disk 2 is made of a material comprising copper, although in other examples, it may also be made of other materials with excellent conductivity.

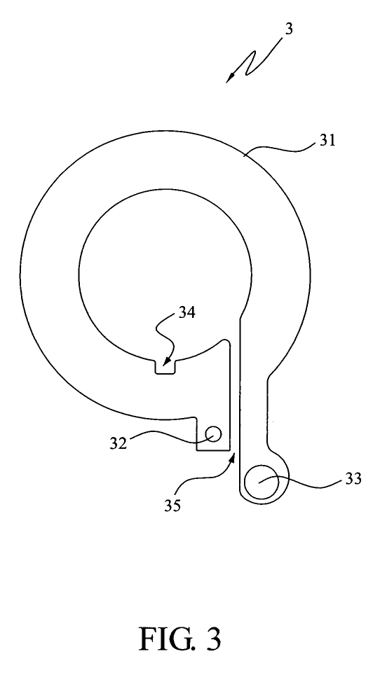

The second conductive disk 3 is also substantially of a circular shape identical to that of the first conductive disk 2, which has a second open circular portion 31, a second connection hole 32, a second wiring terminal 33 and a notch 34. The second open circular portion 31 is formed with a second opening 35, a schematic view of which is shown in FIG. 3. In other words, the second opening 35 also results in the second open circular portion 31 with two separated ends. The second connection hole 32 is formed at one end for connection and fixing purposes, and the second wiring terminal 33 is disposed extending from the other end to connect the power supply terminals. The notch 34 is formed at a circular inner periphery of the second conductive disk 3, and will be described later in terms of its functionality. In this embodiment, the second conductive disk 3 is made of a material comprising copper, although in other examples, it may also be made of other materials with excellent conductivity.

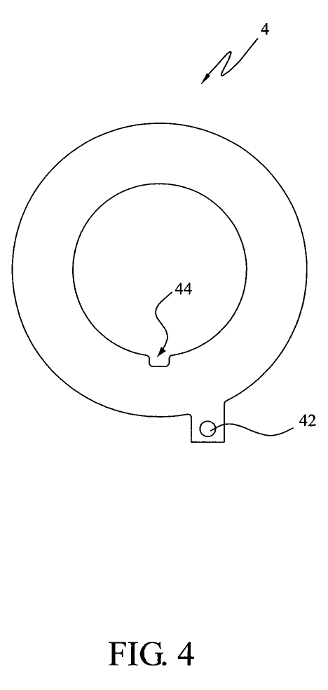

As shown in FIG. 4, the insulation disk 4 is also substantially of a circular shape identical to those of the first conductive disk 2 and the second conductive disk 3, which has a third connection hole 42 and a notch 44. The third connection hole 42 is formed at a location corresponding to the first connection hole 22 and the second connection hole 32. The insulation disk 4 is disposed between the first conductive disk 2 and the second conductive disk 3 for the purpose of blocking the partial electrical connection between the first open circular portion 21 and the second open circular portion 31 to prevent the occurrence of short circuits between the first conductive disk 2 and the second conductive disk 3. The notch 44 is formed at a circular inner periphery of the insulation disk 4, and will be described later in terms of its functionality. In this embodiment, the insulation disk 4 is made of a material comprising polyimide, although in other examples, it may also be made of other materials that will readily occur to those skilled in the art.

Additionally, as the first conductive disk 2, the second conductive disk 3 and the insulation disk 4 are all substantially of a circular shape in this embodiment, the notches 24, 34 and 44 are formed at the circular inner peripheries of the first conductive disk 2, the second conductive disk 3 and the insulation disk 4 respectively to ensure correct relative positions among the first conductive disk 2, the second conductive disk 3 and the insulation disk 4. Hence, during the assembly of the winding structure 5, these notches may serve as positional references for adjusting the relative positions of the components to facilitate the assembly process.

It should be noted that the first open circular portion 21, the second open circular portion 31 and the insulation disk 4 are not limited to the circular shape described in this embodiment, and in other applications, they may also be modified into an elliptical circular shape, a rectangular circular shape or an irregular circular shape depending on practical needs. Hence, the first conductive disk 2, the second conductive disk 3 and the insulation disk 4 may be stamped separately.

FIG. 5 illustrates a schematic view of a winding structure 5 of the present invention after being assembled. The connecting part 52 is inserted through the first connection hole 22, the second connection hole 32 and the third connection hole 42 to combine the first conductive disk 2, the second conductive disk 3 and the insulation disk 4 together. Also, by virtue of the electrical conductive properties of the connecting part 52, the electrical connection between the first conductive disk 2 and the second conductive disk 3 is achieved. In this embodiment, the connecting part 52 is a rivet; however, in other examples, other appropriate connecting parts may be used instead by those skilled in the art. Thus, susceptibility to fracture at the junctures during the folding process as would occur in the prior art is obviated.

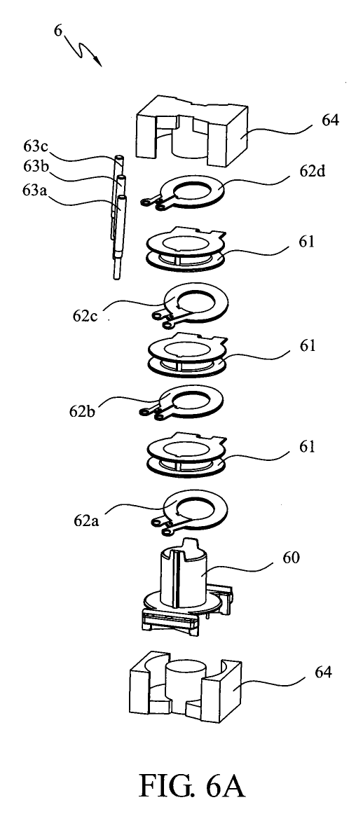

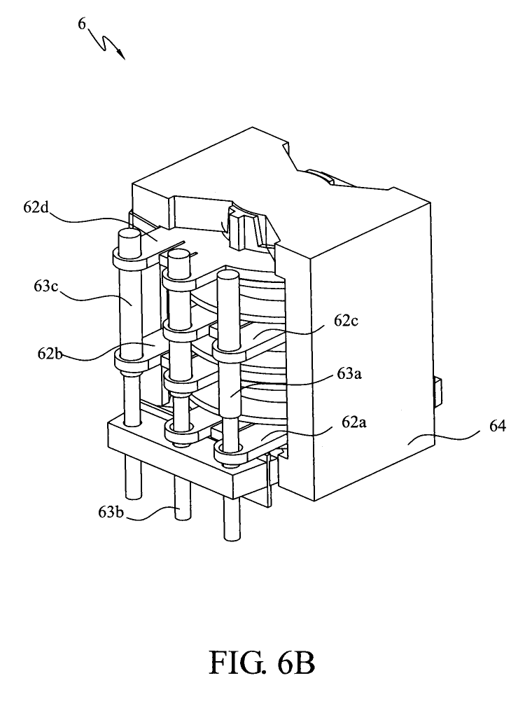

The winding structure of the present invention is applicable to a secondary winding 6 of a transformer, a schematic exploded view and a schematic assembled view of which are shown in FIGS. 6A and 6B respectively. The secondary winding 6 comprises a bobbin base 60, three bobbins 61, four winding structures 62a, 62b, 62c, 62d, three conductive posts 63a, 63b, 63c and a core set 64. The winding structures 62a, 62b, 62c, 62d may adopt the winding structure 4 as described in the previous embodiment, so details of the structure thereof will not be further described herein again. In other examples, amounts of the bobbins 61 and the winding structures 62a, 62b, 62c, 62d may vary as desired.

The bobbins 61 are substantially hollow circular bobbins staggered with the winding structures 62a, 62b, 62c, 62d to fix the positions of and relative distances among the winding structures 62a, 62b, 62c, 62d. The bobbin base 60 has a cylindrical element that penetrates through the bobbins 61 and the winding structures 62a, 62b, 62c, 62d to fix them together. The conductive posts 63a, 63b, 63c are made of a material comprising copper, and are soldered to the wiring terminals of the winding structures 62a, 62b, 62c, 62d for electrically connecting the winding structures 62a, 62b, 62c, 62d. Then, the core set 64 is used to combine the bobbin base 60, the bobbins 61 and the winding structures 62a, 62b, 62c, 62d together to form the secondary winding 6 of the transformer.

When electromagnetic induction takes place between a primary winding and the secondary winding 6, an electric current flows through the secondary winding 6 in a direction from the conductive post 63a into the wiring terminals of the winding structures 62a and 62c that are connected in parallel. The current flows to the conductive post 63b in the counterclockwise direction, flows into the wiring terminals of the winding structures 62b and 62d that are connected in parallel, then flows again in the counterclockwise direction, and finally flows out of the secondary winding 6 from the conductive post 63c.

According to the above descriptions, the main components of the winding structure of the present invention are formed separately and then structurally and electrically assembled together by means of the connecting part. As a result, the conductive components and the insulation components may be stamped separately, thereby preventing short circuits and fracture at the junctures. Further, as compared to the prior art that requires an insulation adhesive tape to be attached to the winding disks, the insulation disk of the present invention may be made of a material that can endure a high temperature, thereby providing more flexibility in use. Therefore, the problems confronted by the prior art are eliminated in the winding structure of the present invention.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A winding structure for use in a transformer, comprising:
a first conductive disk, having a first open circular portion and a first connection hole;
a second conductive disk, having a second open circular portion and a second connection hole;
an insulation disk, having a third connection hole and being disposed between the first conductive disk and the second conductive disk; and
a connecting part, being configured to combine the first conductive disk, the second conductive disk and the insulation disk through the first connection hole, the second connection hole and the third connection hole, and enabling the electrical connection between the first conductive disk and the second conductive disk.

2. The winding structure as claimed in claim 1, wherein the first conductive disk further has a first wiring terminal which is extendedly disposed at one end of the first open circular portion, and the second conductive disk further has a second wiring terminal which is extendedly disposed at one end of the second open circular portion.

3. The winding structure as claimed in claim 2, wherein the first open circular portion has a first opening which is substantially formed between the first connection hole and the first wiring terminal, and the second open circular portion has a second opening which is substantially formed between the second connection hole and the second wiring terminal.

4. The winding structure as claimed in claim 1, wherein the insulation disk is configured to insulate part of the electrical connection between the first open circular portion and the second open circular portion.

5. The winding structure as claimed in claim 1, wherein the first open circular portion, the second open circular portion and the insulation disk substantially have the same shape which is one of a circular shape, an ellipse circular shape, a rectangle circular shape and an irregular circular shape.

6. The winding structure as claimed in claim 1, wherein the connecting part is a rivet.

7. The winding structure as claimed in claim 1, wherein each of the first conductive disk, the second conductive disk and the insulation disk has a slot, and the slots are substantially the same shape and formed at corresponding locations.

8. The winding structure as claimed in claim 1, wherein the first conductive disk and the second conductive disk are made of a material comprising copper.

9. The winding structure as claimed in claim 1, wherein the insulation disk is made of a material comprising polyimide.

10. The winding structure as claimed in claim 1, wherein the winding structure is for use as a secondary winding of the transformer.

11. A winding for use in a transformer, comprising:
a plurality of bobbins;
a plurality of winding structures as claimed in claim 1, being staggered with the bobbins;
a plurality of conductive posts, being configured to electrically connect to the winding structures; and
a core set, being configured to combine the bobbins and the winding structures.

12. The winding as claimed in claim 11, wherein the conductive posts are made of a material comprising copper.
